(19) United States
(12) Patent Application Publication
(10) Pub. No.: US 2006/0282392 A1
(43) Pub. Date: Dec. 14, 2006

(54) Method and apparatus for dynamically controlling the selection and redundancy of web services components

(75) Inventors: Clair Lewis Ewert, Rochester, MN (US); James Robin Fritsch, Rochester, MN (US); Lars Roger Iversen, Karlslunde (DK); James M. Kidd, Rochester, MN (US); Merrill Dean Lindberg, Rochester, MN (US)

Correspondence Address: Grant A. Johnson;IBM Corporation, Dept. 917, 3605 Highway 52 North, Rochester, MN, 55901-7829, US

(73) Assignee: International Business Machines Corporation, Armonk, NY (US)

(21) Appl. No.: 11/149,479

(22) Filed: Jun. 9, 2005

(51) Int. Cl. G06Q 99/00

(52) U.S. Cl. 705/59

(57) ABSTRACT

An electronic proof of entitlements management system that provides the ability to create entitlement record based on customer entitlement purchase, to update elements of the entitlement entity based on entitlement owner authority, and to transfer entitlements to other computer system, both intra-organization and inter-organization. The electronic proof of entitlements in some embodiments are retained and maintained in an Internet-accessible license management database that can be used by customers via web-based support tools to access, view, print, transfer and update the electronic proofs of entitlement. These electronic proofs of entitlement may also be used by software vendor to verify entitlement for software upgrades and process purchases of additional entitlement.

The present invention generally relates to establishing, verifying, and managing computer software access rights. More specifically, the present invention relates to creating and managing electronic proof of entitlements to computer software.

### BACKGROUND

The development of the EDVAC computer system of 1948 is often cited as the beginning of the computer era. Since that time, computer systems have evolved into extremely sophisticated devices, and computer systems may be found in many different settings. Computer systems typically include a combination of hardware, such as semiconductors and circuit boards, and software, also known as computer programs. As advances in semiconductor processing and computer architecture push the performance of the computer hardware higher, more sophisticated and complex computer software has evolved to take advantage of the higher performance of the hardware, resulting in computer systems today that are dramatically more powerful than just a few years ago.

Commercial software programs are typically licensed to customers in return for a license fee. These license fees can be many thousands of dollars per year for complex software designed to perform mission critical tasks. When significant license fees are involved, both customers and commercial software developers are keenly interested in ensuring that the customer pays for no more or no less than what they should.

Many licenses, particularly those directed at more expensive software packages, state that the customer can use the program at a specified level, such as on a single machine with two central processing units. Traditionally, customers documented their entitlement to use a program and developers verified that the customer had the right to use those programs through a printed document called a Proof of Entitlement (“PoE”). These PoE's are typically distributed to a customer with their initial software program purchase, or by the purchase of additional entitlement, and describes product information and the quantity of entitlement purchased. The PoE's may sometimes supplemented with a serial number that the customer is required to enter into their system at initial program load.

With increasing use of server virtualization, managing these certificates has become significant problem. Unlike the past when hardware upgrades were a relatively rare event, today's virtualized servers are designed to allow customers to easily transfer workloads from one system to another and/or to change the capacity of their existing servers. Unfortunately, customers must often locate the PoE documents for follow-on software release upgrades and/or to substantiate current entitlement for additional entitlement purchases. Failure to produce the original PoE may result in a customer having to purchase a product or upgrade at a non-discounted price. In certain instances, the current PoE must be destroyed when a new PoE is shipped.

Without a way to allow customers to more easily document proof of entitlement, the promise of virtualization may never be fully achieved.

### SUMMARY

The present invention provides electronic proof of entitlements (“ePoEs”) and an ePoE management system with the ability to create entitlement record based on customer entitlement purchase, to update elements of the entitlement entity based on entitlement owner authority, and to transfer entitlements to other computer system, both intra-organization and inter-organization. The ePoEs in some embodiments are retained and maintained in an Intemet-accessible license management database that can be used by customers via web-based support tools to access, view, print, transfer and update the ePoEs. These ePoEs may also be used by software vendor to verify entitlement for software upgrades and process purchases of additional entitlement.

One aspect of the present invention is a method for managing entitlements to computer software, comprising receiving an request from a customer for entitlement to use a computer software product on one or more computer platforms, generating an electronic proof of entitlement containing a key that enables use of the computer software product only on the specified one or more computer platforms, and providing access to the electronic proof of entitlement from a customer facility. Another aspect of the present invention is a method for deploying computing infrastructure, comprising integrating computer readable code into a computing system, wherein the code in combination with the computing system is capable of performing a method for managing entitlements to computer software comprising receiving an request from a customer for entitlement to use a computer software product on one or more computer platforms, generating an electronic proof of entitlement containing a key that enables use of the computer software product only on the specified one or more computer platforms, and providing access to the electronic proof of entitlement from a customer facility. Yet another aspect of the present invention is a computer program product comprising a program configured to perform a method for managing entitlements to computer software and a computer readable signal bearing media bearing the program. The program in these embodiments causes the computer to receive a request from a customer for entitlement to use a computer software product on one or more computer platforms, generate an electronic proof of entitlement containing a key that enables use of the computer software product only on the specified one or more computer platforms, and provide access to the electronic proof of entitlement from a customer facility.

The present invention and its ePoE management system provides numerous advantages over conventional, physical PoE systems. For example, each ePoE record created is unique world-wide, and is created for the specific customer ordering the software program product for use on a specific machine as part of the software manufacturing and delivery process. The ePoE record may be accessed by the customer purchasing the software product over the Internet, may be aggregated across hardware owned by that customer, and is accessible by the system vendor for use in software maintenance upgrades.

### BRIEF DESCRIPTION OF THE DRAWINGS

FIG. 1 depicts one embodiment of an electronic proof of entitlement management system.

FIG. 2 depicts the operation of a world-wide key management system embodiment.

FIG. 3 depicts one method of creating an electronic proof of entitlement.

FIGS. 4a-4c depict one embodiment of customer license agent access and registration system.

FIGS. 5a-5d depict one embodiment of an electronic proof of entitlement management user interface.

FIG. 6 illustrates a computer system suitable for use as a customer computer system or an electronic proof of entitlement management system.

### DETAILED DESCRIPTION

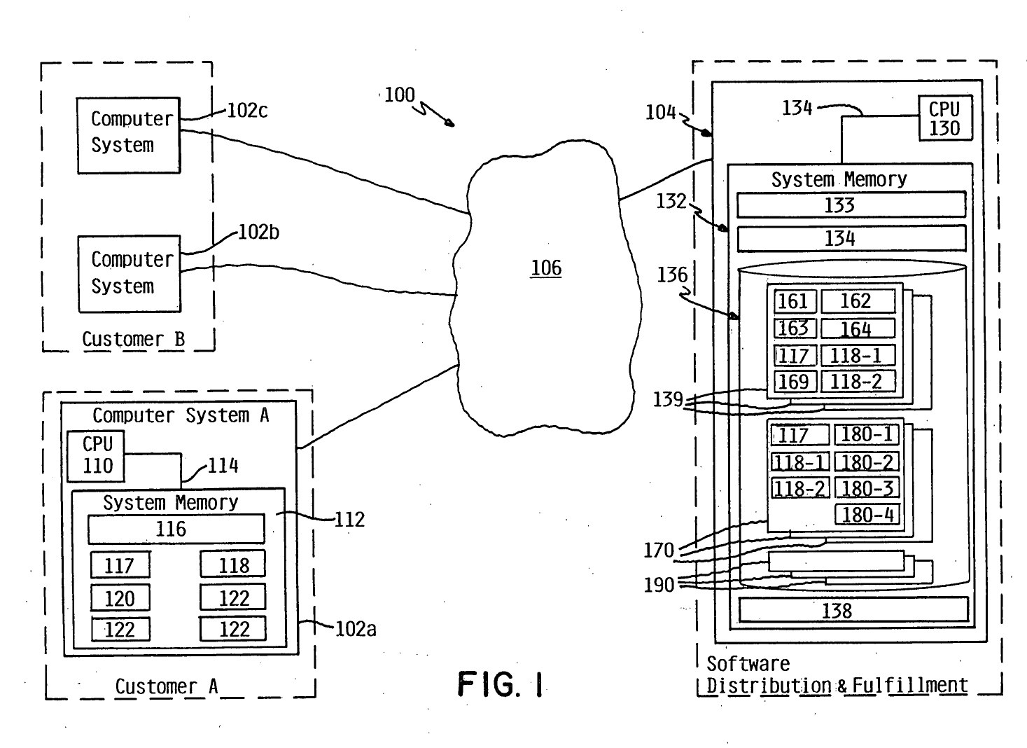

FIG. 1 depicts one embodiment of an electronic proof of entitlement (“ePoE”) management system 100. This ePoE management system 100 comprises a plurality of customer computer systems 102 located at the customer's place of business, and at least one ePoE management system 104 located at a software distribution and fulfillment (“SDF”) facility owned by a hardware system vendor. Each customer system 102 includes a central processing unit 110 connected to a memory 112 by a system bus 114. The memory 112 contains an operating system 116, a customer number 117 uniquely associated with a particular customer, a hardware serial number 118 uniquely associated with one particular customer system 102, a software ordering module 120, and a plurality of software application programs 122. The ePoE management system 104 includes a central processing unit 130 connected to a memory 132 by system bus 134. The memory 132 of the ePoE management system 104 contains an operating system 133, configurator 134, a license management system (“LMS”) database 136, and a world-wide key management system 138 (“WWKMS”). The LMS database 136 in this embodiment contains a plurality of ePoEs 139, each comprising a product identifier 160, a product name 162, a version identifier 163, an entitlement indicator 164, the customer identification number 117, one or more hardware serial number 118 on which a copy of the software product will be installed, and a software key 169 for each copy of the software product that will be installed. The LMS database 136 in this embodiment also contains a plurality of customer license agent (“CLA”) profile records 170 comprising the customer identifier(s) 117 and hardware serial number(s) 118 for the computer systems 102 on which the CLA is authorized to manage; and a plurality of system records 180, collectively containing the current hardware and software configuration of every customer system 102. Some embodiments may also include one or more enterprise identification number 190 that contain a list of customer numbers owned by an entire enterprise, such as a large corporation or governmental entity. The customer systems 102 and the ePoE management system 104 are communicatively coupled together by a communications medium 106, such as the Internet.

In operation, the ePoE management system 100 embodiment in FIG. 1 creates ePoE(s) 139 that can be stored as records in the LMS database 136. These unique records are based upon the software product order information from the customer, and include the software product and support level, the customer identifier 117, and the hardware serial number 118. That is, the ePoE(s) 139 in this embodiment are uniquely associated a specific customer (via the customer number 117), a specific software product and support level (via the product identifier 160), and a specific customer system 102 (via the hardware serial number 118). In this way, the ePoE(s) 139 become a worldwide record of entitlement to use a specific purchased software product on a specific customer system 102.

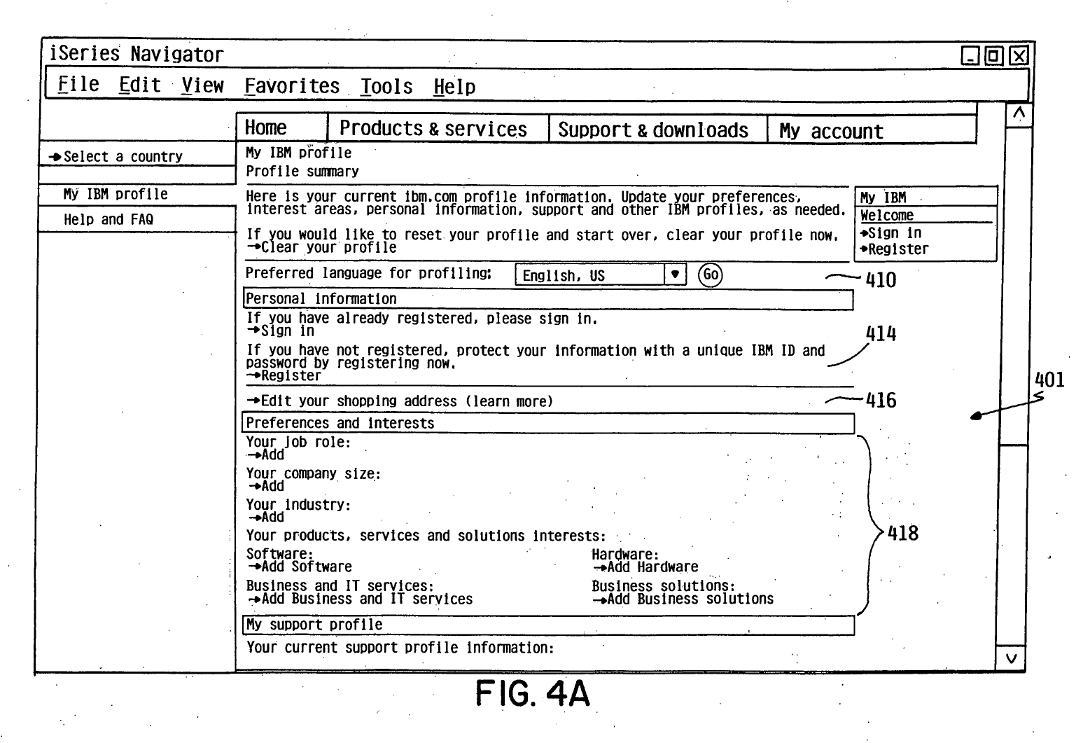

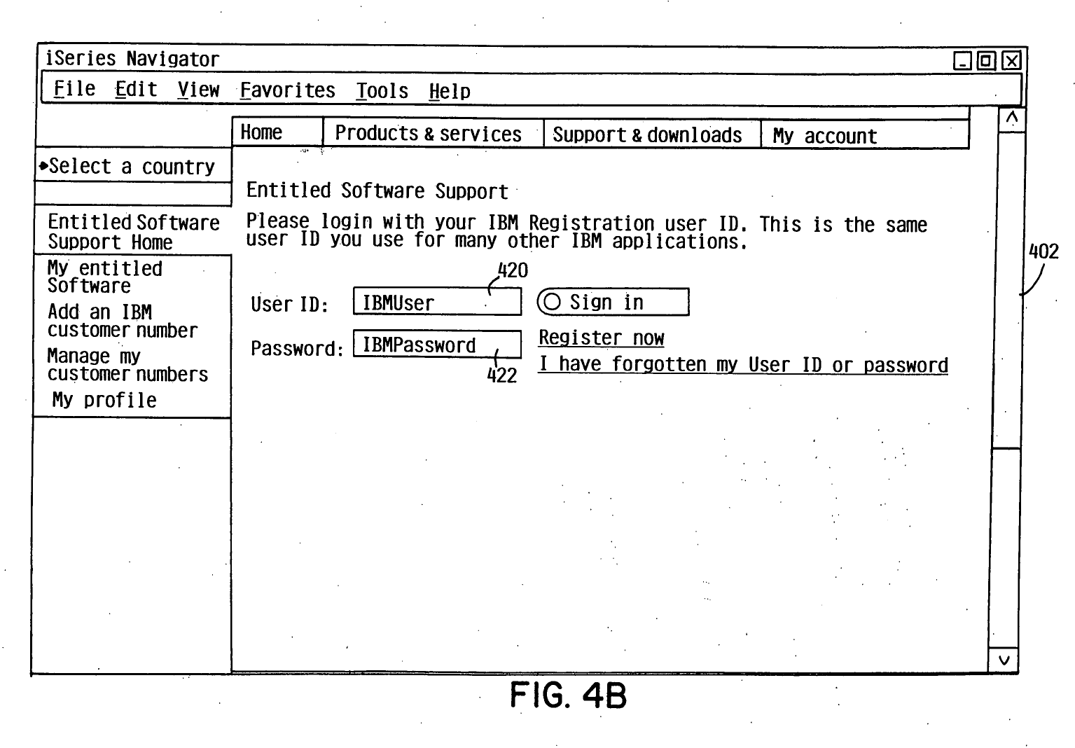

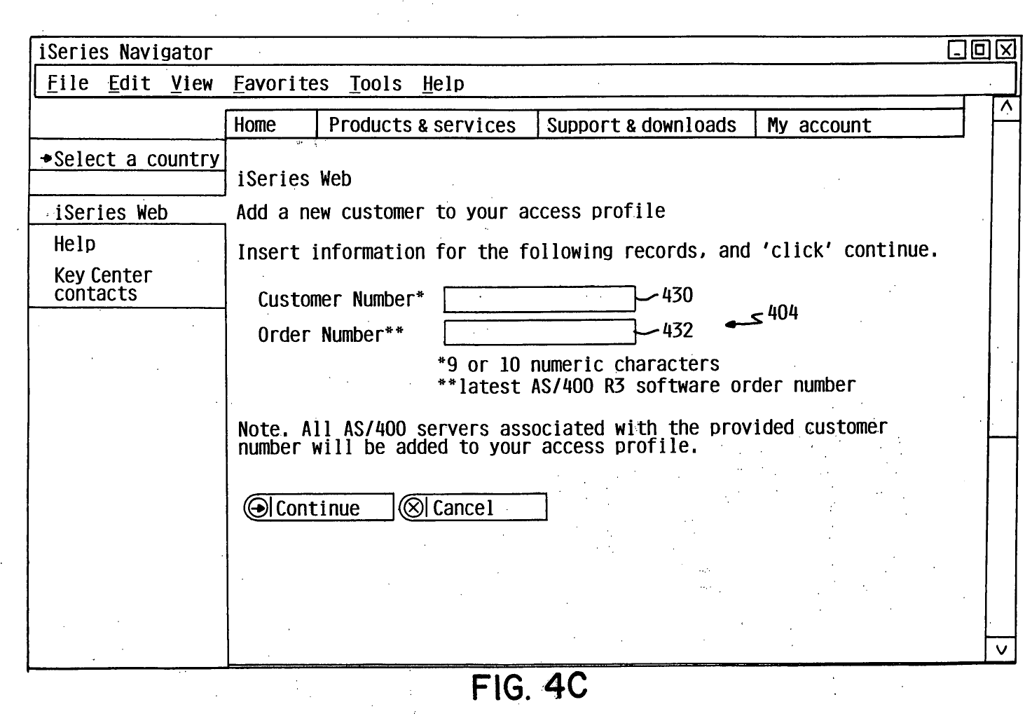

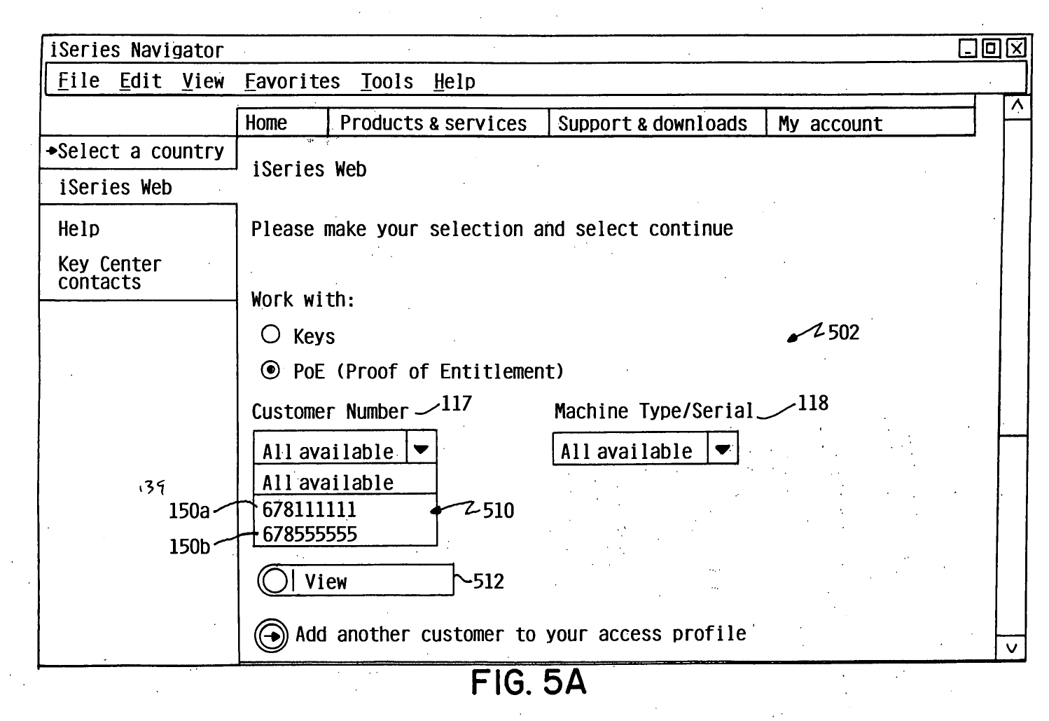

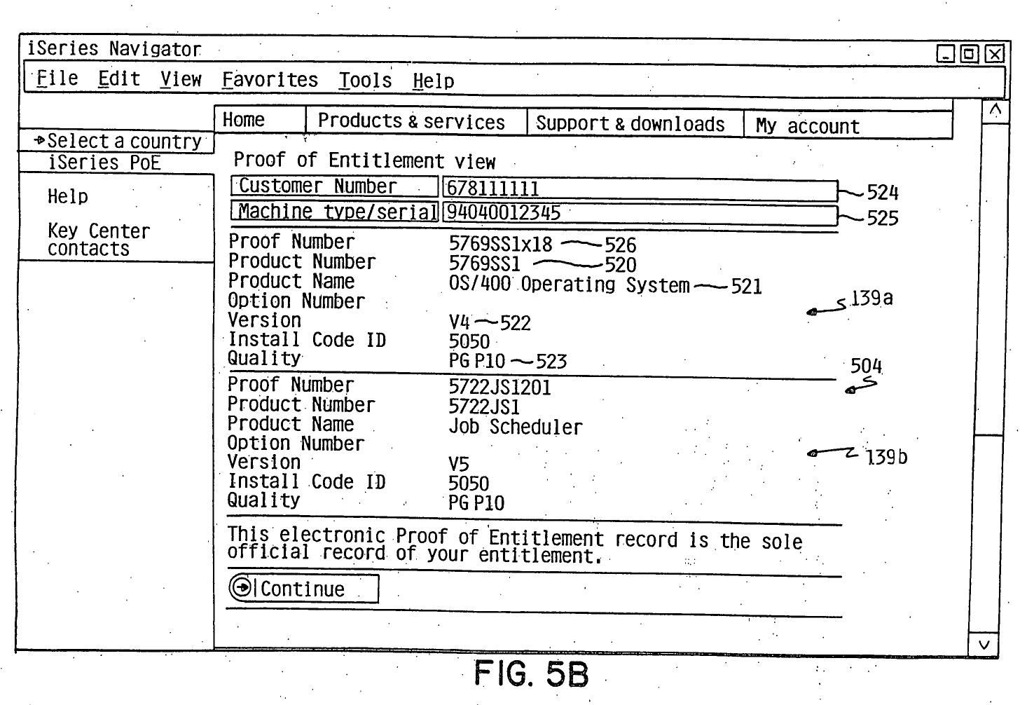

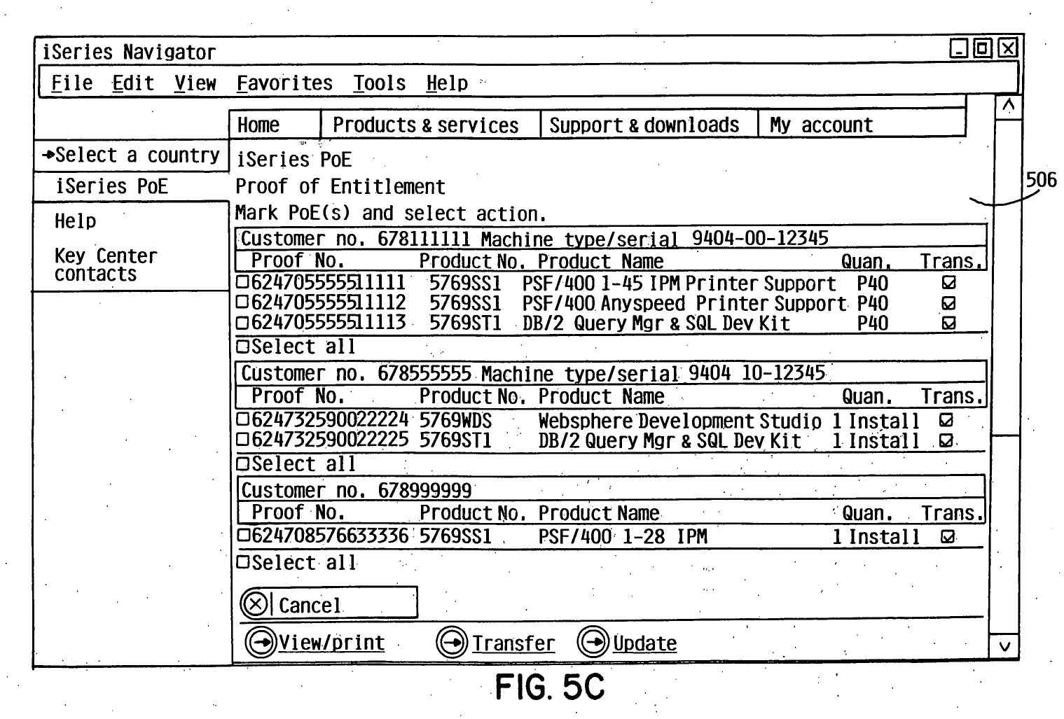

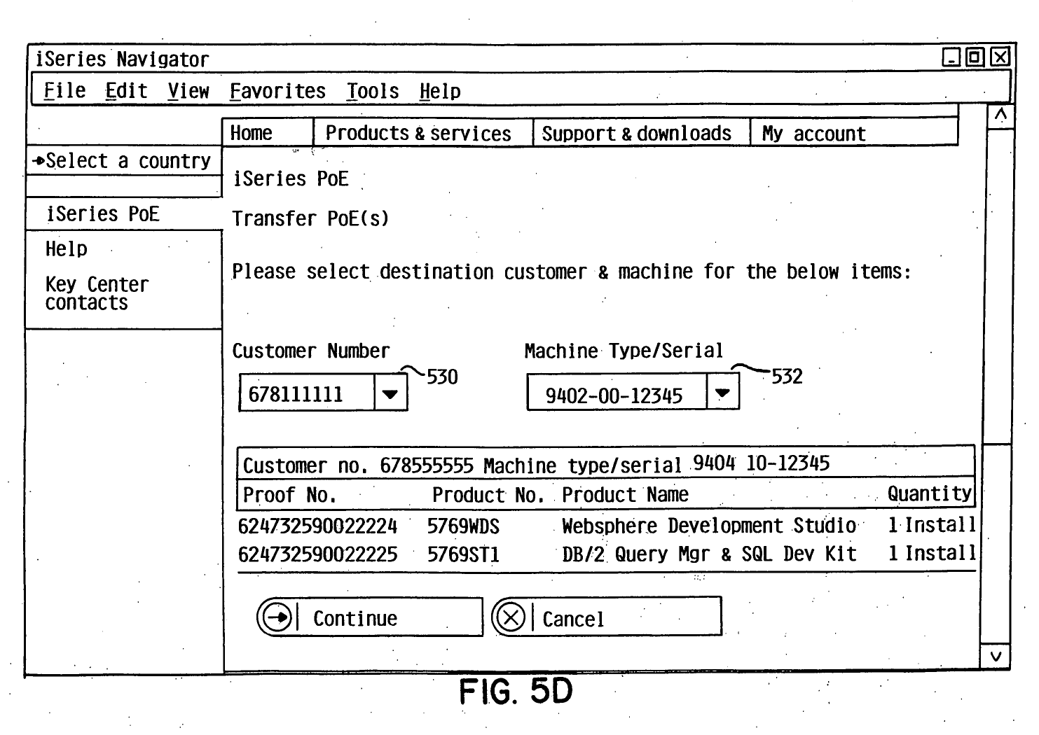

The system vendor in this embodiment provides the CLA's with a web-based application. Once registered with the system vendor via the common registration tool (described in more detail with reference to FIGS. 4-5), the CLA can display and manage their organization's ePoE(s) 139. More specifically, this Internet-based support system allows the CLA to view, print, update ePoE(s) 139 and to transfer ePoE(s) 139 both within an organization (i.e., intra-organization transfers) and between organizations (i.e., inter-organization transfers). Significantly, the customer does not need to receive or produce a physical entitlement record because all entitlement support work can be done via Internet-based interactions. That is, the ePoE database support replaces the physical documentation conventionally prepared by the system manufacturer for customer entitlement-related activities. The many burdens associated with the customer's having to locate the physical-PoE documentation in the physical software package shipment, to inventory the physical documentation, and to maintain the physical documentation through subsequent product entitlement changes are significantly improved with the ePoE management system 100 of the present invention. Moreover, there is no possibility of losing or misplacing the ePoE 139 because the ePoEs are available on the web for customer processing support once it is created by the system manufacturer. The ePoE 139 can be updated per customer interface support to reflect future hardware system installations, transfers to another system, and associated software support level changes. In some embodiments, the LVM database may further maintain a history of these changes.

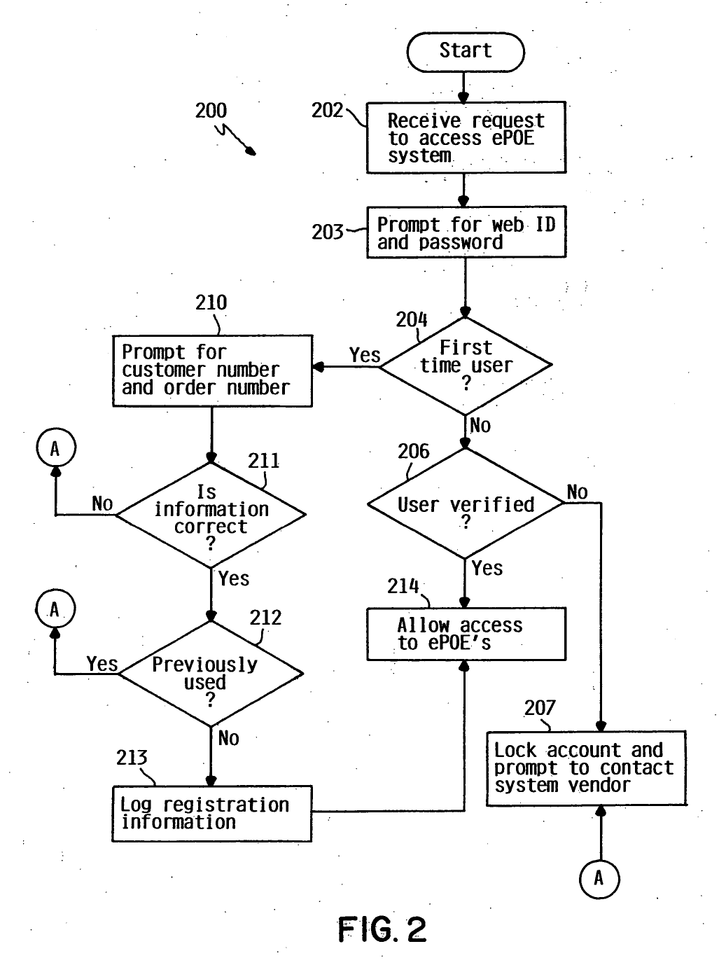

FIG. 2 depicts the operation of the WWKMS 138 in more detail. At block 202, the WWKMS 138 receives a request to access the system from a customer license administrator (“CLA”). At block 203, the WWKMS 138 prompts the CLA to enter their existing web identifier and password, or to enter a new web identifier and password. The WWKMS 138 then checks at block 204 whether the submitted web identifier has previously been used to access the ePoE system. If this is the CLA's first access, the WWKMS 138 prompts the CLA to create a profile at block 210-214; otherwise it proceeds to block 206. At bock 206, the WWKMS 138 verifies that the submitted password matches a previously submitted password. If the web identifier and password match, the WWKMS 138 allows the CLA to view, print, update, and transfer ePoEs 139 for the registered country, customer, and machines at block 214; otherwise, the WWKMS 138 locks the web identifier at block 207 until the CLA re-verifies their identity. In some embodiments, the WWKMS 138 may allow a limited number of retries before locking the web identifier.

If the WWKMS 138 determined at flow 204 that this is the first time the CLA has accessed the ePoE management system 100, the WWKMS 138 asks the CLA to enter information at block 210 sufficient to verify that the CLA is an authorized agent of the customer. In this embodiment, the authorization information comprises the vendor's customer identification number 117 for the CLA's organization, at least one order number previously placed by that customer. At block 211, the WWKMS 138 verifies that the designated customer had previously placed the designated order for delivery to the designated country. This checkpoint is desirable to ensure that the CLA is part of the designated customer organization. At block 212, the WWKMS 138 determines whether the combination of order number and customer number has been used more than once previously to register a new CLA. This checkpoint is desirable to avoid misusage of the underlying data. If the checkpoints performed at blocks 211 and 212 are both successful, the WWKMS 138 logs the information used to give access to the ePoE system at block 213. The WWKMS 138 then allows the newly authorized CLA to view, print, update, and transfer ePoE(s) 139 for the registered country, customer, and machines. For embodiments that use enterprise customer numbers 190, the WWKMS 138 may further allow the CLA to validate that the ePoE-owning customer number is listed under the enterprise customer number 190 in the LMS database 136 at block 214, and if this relationship exists, to remove the ePoE from a specific hardware serial number 118 in the LMS database 136 and add the ePoE 139 to the transferee serial number 118n in the LMS database 136 at block 214. If either of the checkpoints performed at blocks 211 and 212 are unsuccessful, the WWKMS 138 prompts the CLA to contact the system vendor and then locks the web id. In some embodiments, the WWKMS 138 may also allow a limited number of retries (not shown).

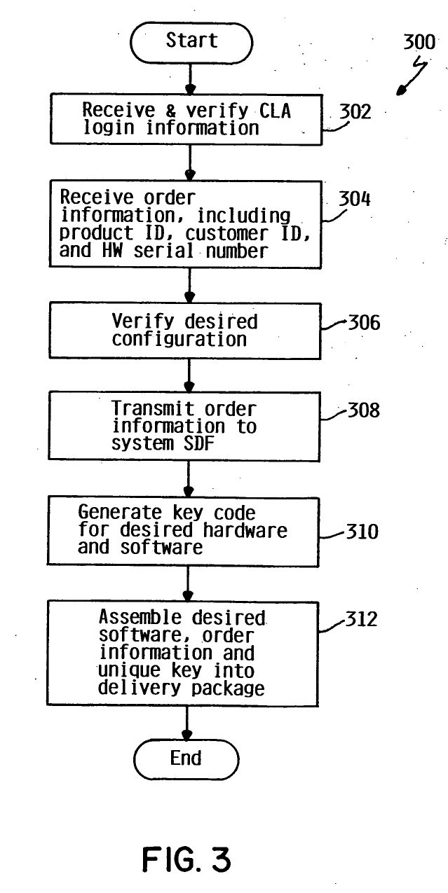

FIG. 3 depicts one method 300 of creating an ePoE 139. At block 302, the CLA logs into the ePoE management system 100. The CLA then places an order with a vendor or a business partner for new or upgraded hardware and/or software at block 304. This order includes the desired product/update identifier 160, the CLA's organization's customer identification number 117, and the hardware serial number(s) 11 8n of the customer system(s) 102 on which the indicated product 160 will be installed. The customer can also specify whether they want electronic software delivery or physical delivery at this time. At block 306, the vendor or business partner reviews the desired configuration, both hardware and software, confirms that the customer has all of the necessary prerequisites, and then submits the order to the SDF at block 308. The SDF uses this information at blocks 310-312 to assemble a customized order package for the customer at block 310. Part of this order package includes information about how to access the ePoE management system 100, a packing list containing their customer number 117, and an order number for this purchase. The SDF also uses this information at block 310 to generate an ePoE record containing a unique key code 169n that will allow the CLA to install and run the desired software product on the specified machine(s), and only on the specified machine(s). That is, unlike conventional serial numbers, the unique key code 169n generated at block 310 will only authorize the selected software product to run on the selected physical device. As a result, license restrictions such as single vs. multiple use on a computer system, quantity of purchased users for the program, processor performance tier usage restriction, etc can be established for data capture and enforcement. Moreover, configured product order parameters are can be captured for subsequent retrieval and customer use.

FIGS. 4a-4c depict one embodiment of a CLA access and registration system 400. The CLA uses this web page to generate a CLA profile, which allows the CLA to access the entitlement records and software keys for the customer number for which the software product was manufactured and to whom it was shipped. Once the registration is complete, the CLA will be known to the vendor by their web identifier and authenticated by their password. This registration system 400 comprises a profile summary page 401, a login page 402, and a create profile page 404. The profile summary page 401 contains links and fields that allow the CLA to specify their desired language 410, to sign into an existing account 412 (see FIG. 4a), to select a user name and password for a new account 414, to enter their default shipping address 416, and to indicate any areas of interest 418. The login page 401 contains a web id field 420 and a password field 422. The create profile page 404 contains a customer number field 430 in which the CLA can enter the customer number 117 for which the software product was manufactured and to which it was shipped, and an order number field 432 identifying a specific order shipped to the specified customer. As discussed with reference to FIG. 3, the software packing list shipped with the product from the SDF location contains this information in some embodiments. Once the data has been accepted by ePoE management system 100, the CLA can then manage all of the customer's existing LMS entitlements and software keys in the database 136. In addition, once the customer has been registered and verified, there is no need to do so again in this embodiment. The saved User ID and Password combination can be used to enter the ePoE management system 100 in the future.

FIGS. 5a-5d illustrates one embodiment of an ePoE management user interface 500. This interface 500 comprises a selection page 502, an information page 504, a management page 506, and a transfer page 507. The selection page displays a list 510 of ePoE's 139a-139n the CLA can manage, sorted by customer number 117 and hardware serial number 118. Selecting one or more of the ePoEs 139 from the selection page brings and hitting the view button 512 brings up an associated ePoE information page 504 The information page 504 contains information from the ePoE(s), including a product ID field 520 contain the product identifier 160, a product name field 521 containing the product name 162, a version field 522 containing the product version 163, a quantity field 523 containing the amount of purchased entitlement, a customer number field 524 containing the customer number 117 that purchased the enfitlement, a machine type/serial number field 525 containing the hardware serial number 118 for the customer system 102 on which the product is currently installed or on which it will be installed, and a proof number 526 containing a worldwide unique proof number assigned to this record. Selecting one of the ePoEs 139 from the selection page 502 and hitting the transfer button 514 bring up the transfer page 507, which comprises a destination customer number field 530 and a destination machine serial number field 532 in which the CLA can identify the customer system 102n to which the entitlement(s) 139 should be transferred.

One feature and advantage of the embodiment described with reference to FIGS. 1-5 is that the CLA can manage the ePoE(s) without being signed into the particular system on which the software is installed. This is desirable because, in many situations where entitlements are transferred between organizations, the customer system 102 has been removed from operational service and is no longer capable of being powered up for this transfer to occur or there are company security and firewall restrictions that prevent web access to from the customer system 102.

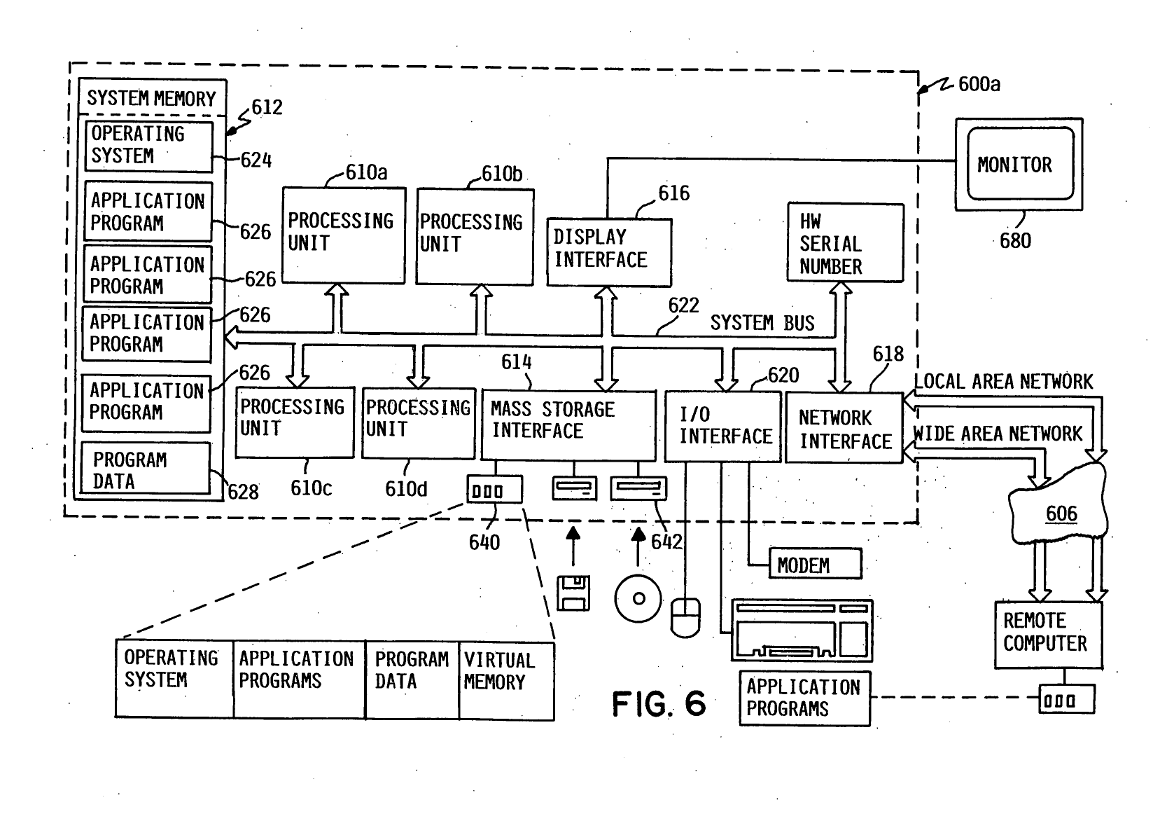

FIG. 6 illustrates a computer system 600 suitable for use as a customer computer system 102 or an ePoE management system 104. It should be understood that this figure is only intended to depict the representative major components of the computer system 600 and that individual components may have greater complexity that represented in FIG. 6. Moreover, components other than or in addition to those shown in FIG. 6 may be present, and that the number, type, and configuration of such components may vary. Several particular examples of such additional complexity or additional variations are disclosed herein; it being understood that these are by way of example only and are not necessarily the only such variations.

This computing system 600 embodiment comprises a plurality of central processing units 610a-610d (herein generically referred to as a processor 610 or a CPU 610) connected to a main memory unit 612, a mass storage interface 614, a terminal/display interface 616, a network interface 618, and an input/output (“I/O”) interface 620 by a system bus 622. The mass storage interfaces 614, in turn, connect the system bus 622 to one or more mass storage devices, such as a direct access storage device 640 or a readable/writable optical disk drive 642. The network interfaces 618 allow the computer system 600 to communicate with other computing systems 600 over the communications medium 606. The main memory unit 612 in this embodiment also comprises an operating system 624, a plurality of application programs 626 and some program data 628.

The computing system 600 in this embodiment is a general-purpose computing device. Accordingly, the CPU's 610 may be any device capable of executing program instructions stored in the main memory 612 and may themselves be constructed from one or more microprocessors and/or integrated circuits. In this embodiment, the computing system 600 contains multiple processors and/or processing cores, as is typical of larger, more capable computer systems; however, in other embodiments the computing systems 600 may comprise a single processor system and/or a single processor designed to emulate a multiprocessor system.

When the computing system 600 starts up, the associated processor(s) 610 initially execute the program instructions that make up the operating system 624, which manages the physical and logical resources of the computer system 600. These resources include the main memory 612, the mass storage interface 614, the terminal/display interface 616, the network interface 618, and the system bus 622. As with the processor(s) 610, some computer system 600 embodiments may utilize multiple system interfaces 614, 616, 618, 620, and busses 622, which in turn, may each include their own separate, fully programmed microprocessors.

The system bus 622 may be any device that facilitates communication between and among the processors 610; the main memory 612; and the interfaces 614, 616, 618, 620. Those skilled in the art will appreciate that the system bus 622 may be a relatively simple, single bus structure that provides a direct communication path among the system bus 622 (as depicted in FIG. 6), or may be a more complex structure, such as point-to-point links in hierarchical, star or web configurations; multiple hierarchical buses; parallel and redundant paths, etc.

The main memory 612 and the mass storage devices 640 work cooperatively in this to store the operating system 624, the application programs 626, and the program data 628. In this embodiment, the main memory 612 is a random-access semiconductor device capable of storing data and programs. Although FIG. 6 conceptually depicts this device as a single monolithic entity, the main memory 612 in some embodiments may be a more complex arrangement, such as a hierarchy of caches and other memory devices. For example, the main memory 612 may exist in multiple levels of caches, and these caches may be further divided by function, so that one cache holds instructions while another holds non-instruction data, which is used by the processor or processors. Memory may be further distributed and associated with different CPUs 610 or sets of CPUs 610, as is known in any of various so-called non-uniform memory access (NUMA) computer architectures. Moreover, some embodiments may utilize virtual addressing mechanisms that allow the computing systems 600 to behave as if it has access to a large, single storage entity instead of access to multiple, smaller storage entities such as the main memory 612 and the mass storage device 640.

Although the operating system 624, the application programs 626, and the program data 628 are illustrated as being contained within the main memory 612, some or all of them may be physically located on different computer systems and may be accessed remotely, e.g., via the network 106, in some embodiments. Thus, while the operating system 624, the application programs 626, and the program data 628 are illustrated as being contained within the main memory 612, these elements are not necessarily all completely contained in the same physical device at the same time, and may even reside in the virtual memory of other computer systems 600.

The system interface units 614, 616, 618, 620 support communication with a variety of storage and I/O devices. The mass storage interface unit 614 supports the attachment of one or more mass storage devices 640, which are typically rotating magnetic disk drive storage devices, although they could alternatively be other devices, including arrays of disk drives configured to appear as a single large storage device to a host and/or archival storage media, such as hard disk drives, tape (e.g., mini-DV), writeable compact disks (e.g., CD-R and CD-RW), digital versatile disks (e.g., DVD, DVD-R, DVD+R, DVD+RW, DVD-RAM), holography storage systems, blue laser disks, IBM Millipede devices and the like.

The terminal/display interface 616 is used to directly connect one or more display units 680 to the computer system 600. These display units 680 may be non intelligent (i.e., dumb) terminals, such as a cathode ray tube, or may themselves be fully programmable workstations used to allow IT administrators and users to communicate with the computing system 600. Note, however, that while the interface 616 is provided to support communication with one or more displays 680, the computer systems 600 does not necessarily require a display 680 because all needed interaction with users and other processes may occur via network interface 618.

The computing system 600 in FIG. 6 is depicted with multiple attached terminals 680, such as might be typical of a multi-user “mainframe” computer system. In such a case, the actual number of attached devices is typically greater than those shown in FIG. 6, although the present invention is not limited to systems of any particular size. The computing systems 600 may alternatively be a single-user system, typically containing only a single user display and keyboard input, or might be a server or similar device which has little or no direct user interface, but receives requests from other computer systems (clients). In other embodiments, the computing systems 600 may be implemented as a personal computer, portable computer, laptop or notebook computer, PDA (Personal Digital Assistant), tablet computer, pocket computer, telephone, pager, automobile, teleconferencing system, appliance, or any other appropriate type of electronic device.

The network 106 may be any suitable network or combination of networks and may support any appropriate protocol suitable for communication of data and/or code to/from multiple computing systems 600. Accordingly, the network interfaces 618 can be any device that facilitates such communication, regardless of whether the network connection is made using present day analog and/or digital techniques or via some networking mechanism of the future. Those skilled in the art will appreciate that many different network and transport protocols can be used to implement the communication medium 106. The Transmission Control Protocol/Internet Protocol (“TCP/IP”) suite contains suitable network and transport protocols.

The embodiments described with reference to FIGS. 1-6 generally use a client-server network architecture. These embodiments are desirable because the clients 102a can utilize the services of the ePoE management system 104 without either system 102, 104 requiring knowledge of the working details about the other. However, those skilled in the art will appreciate that other network architectures are within the scope of the present invention. Examples of other suitable network architectures include peer-to-peer architectures, grid architectures, and multi-tier architectures. Accordingly, the terms web server and client computer should not be construed to limit the invention to client-server network architectures.

One exemplary computing system 600, particularly suitable for use as a customer system 102 and/or an ePoE management system 104 is an eServer iSeries computer running the i5/OS multitasking operating system, both of which are produced by International Business Machines Corporation of Armonk, N.Y. However, those skilled in the art will appreciate that the methods, systems, and apparatuses of the present invention apply equally to any computing system 600 and operating system combination, regardless of whether one or both of the computer systems 600 are complicated multi user computing apparatuses, a single workstations, lap-top computers, mobile telephones, personal digital assistants (“PDAs”), video game systems, or the like.

Although the present invention has been described in detail with reference to certain examples thereof, it may be also embodied in other specific forms without departing from the essential spirit or attributes thereof. For example, those skilled in the art will appreciate that the present invention is capable of being distributed as a program product in a variety of forms, and applies equally regardless of the particular type of tangible, computer-readable signal bearing medium used to actually carry out the distribution. Examples of suitable tangible, computer-readable signal bearing media include, but are not limited to: (i) non-writable storage media (e.g., read only memory devices (“ROM”), CD-ROM disks readable by a CD drive, and Digital Versatile Disks (“DVDs”) readable by a DVD drive); (ii) writable storage media (e.g., floppy disks readable by a diskette drive, CD-R and CD-RW disks readable by a CD drive, random access memory (“RAM”), and hard disk drives); and (iii) communications media (e.g., computer networks, such as those implemented using “Infiniband”or IEEE 802.3x “Ethernet” specifications; telephone networks, including cellular transmission networks; and wireless networks, such as those implemented using the IEEE 802.11x, IEEE 802.16, General Packet Radio Service (“GPRS”), Family Radio Service (“FRS”), and Bluetooth specifications). Those skilled in the art will appreciate that these embodiments specifically include computer software downloaded over the Internet.

Embodiments of the present invention may also be delivered as part of a service engagement with a client corporation, nonprofit organization, government entity, internal organizational structure, or the like. Aspects of these embodiments may include configuring a computer system to perform, and deploying software, hardware, and web services that implement, some or all of the methods described herein. Aspects of these embodiments may also include analyzing the client's operations, creating recommendations responsive to the analysis, building systems that implement portions of the recommendations, integrating the systems into existing processes and infrastructure, metering use of the systems, allocating expenses to users of the systems, and billing for use of the systems. This service engagement may be directed at providing both end-to-end ePoE services, to providing only the back-end ePoE services, or some combination thereof. Accordingly, these embodiments may further comprise receiving charges from other entities and associating that charge with users of the ePoE management system 100.

The various software components illustrated in FIGS. 1-6 and implementing various embodiments of the invention may be implemented in a number of manners, including using various computer software applications, routines, components, programs, objects, modules, data structures, etc., referred to hereinafter as “computer programs,” or simply “programs.” The computer programs typically comprise one or more instructions that are resident at various times in various memory and storage devices in the computer system, and that, when read and executed by one or more processors in the computer system, cause the computer system to perform the steps necessary to execute steps or elements comprising the various aspects of an embodiment of the invention. The various software components may also be located on different systems 102, 104 than depicted in FIGS. 1-6. Thus, for example, the configurator 134 in some embodiments may reside on the customer's computer system 102 rather than the ePoE management system 104. Similarly, the configurator 134, the LMS database 136, the WWKMS 138 may reside on one or more separate systems 104 that are communicatively coupled via the network 106.

The accompanying figures and this description depicted and described embodiments of the present invention, and features and components thereof. Those skilled in the art will appreciate that any particular program nomenclature used in this description was merely for convenience, and thus the invention should not be limited to use solely in any specific application identified and/or implied by such nomenclature. Thus, for example, the routines executed to implement the embodiments of the invention, whether implemented as part of an operating system or a specific application, component, program, module, object, or sequence of instructions could have been referred to as a “program”, “application”, “server”, or other meaningful nomenclature. Indeed, other alternative hardware and/or software environments may be used without departing from the scope of the invention. Therefore, it is desired that the embodiments described herein be considered in all respects as illustrative, not restrictive, and that reference be made to the appended claims for determining the scope of the invention.

We claim:

1. A method for managing entitlements to computer software, comprising:
receiving an request from a customer for entitlement to use a computer software product on one or more computer platforms;
generating an electronic proof of entitlement containing a key that enables use of the computer software product only on the specified one or more computer platforms; and
providing access to the electronic proof of entitlement from a customer facility.

2. The method of claim 1, further comprising:
authenticating a customer license agent as authorized to for a customer; and
receiving the request from the customer license agent.

3. The method of claim 1, wherein the electronic proof of entitlement further comprises a customer identifier and a hardware serial number.

4. The method of claim 1, further comprising:
receiving a transfer request from the customer, the transfer request identifying a recipient system to which the entitlement will be transferred.

5. The method of claim 4, wherein the recipient system is associated with the customer.

6. The method of claim 4, wherein the recipient system is not associated with the customer.

7. The method of claim 1, providing access to the electronic proof of entitlement comprises:
generating a web page containing information about the electronic proof of entitlement; and
transmitting the web page to the customer facility.

8. The method of claim 7, wherein the web page further comprises electronic proof of entitlement management controls adapted to indicate the request from the customer for entitlement to use a computer software product on one or more computer platforms.

9. The method of claim 1, further comprising receiving a hardware serial number from the customer, wherein the hardware serial number is uniquely associated with the computer platform for which the customer seeks entitlement to use the computer software product.

10. A method for deploying computing infrastructure, comprising integrating computer readable code into a computing system, wherein the code in combination with the computing system is capable of performing the method of claim 1.

11. A computer program product, comprising:
(a) a program adapted to perform a method for managing entitlements to computer software, comprising:
receiving an request from a customer for entitlement to use a computer software product on one or more computer platforms;
generating an electronic proof of entitlement containing a key that enables use of the computer software product only on the specified one or more computer platforms; and
providing access to the electronic proof of entitlement from a customer facility;
(b) a computer readable signal bearing media bearing the program.

12. The computer program product of claim 11, wherein the computer readable signal bearing media is chosen from the group consisting of: information permanently stored on non-writable storage media; alterable information stored on writable storage media; and communications media.

13. The computer program product of claim 11, wherein the computer readable signal bearing media comprises software transmitted over the Internet.

14. The computer program product of claim 11, wherein the electronic proof of entitlement further comprises a customer identifier and a hardware serial number.

15. The computer program product of claim 11, wherein the method for managing entitlements to computer software further comprises receiving a transfer request from the customer, the transfer request identifiing a recipient system to which the entitlement will be transferred.

16. The computer program product of claim 11, wherein the method for managing entitlements to computer software further comprises:
authenticating a customer license agent as authorized to for a customer; and
receiving the request from the customer license agent.

17. An electronic proof of entitlement management system, comprising:
a receiving an request from a customer for entitlement to use a computer software product on one or more computer platforms; and
an electronic proof of entitlement management system adapted to:
(a) generate an electronic proof of entitlement containing a key that enables use of the-computer software product only on the specified one or more computer platforms; and
(b) provide access to the electronic proof of entitlement at a customer facility.

18. The electronic proof of entitlement management system of claim 17 further comprising a database adapted to store the electronic proof of entitlements.

19. The electronic proof of entitlement management system of claim 17 further comprising a configurator adapted to review a system configuration associated with the request.

20. The electronic proof of entitlement management system of claim 17 further comprising an authentication module adapted to authenticate a customer license agent as authorized to for a customer.
